(19) United States
(12) Patent Application Publication
(10) Pub. No.: US 2026/0260587 A1
(43) Pub. Date: Sep. 3, 2026

(54) ELECTRONIC DISPLAY DEVICE, WHICH CAN BE COUPLED TO AN OBJECT, FOR DISPLAYING PRODUCT AND/OR PRICE INFORMATION

(71) Applicant: VusionGroup GmbH, Fernitz-Mellach (AT)

(72) Inventors: Philipp HERRNEGGER, Fernitz-Mellach (AT); Peter GROISS, Laakirchen (AT)

(73) Assignee: VusionGroup GmbH, Fernitz-Mellach (AT)

(21) Appl. No.: 18/720,455

(22) PCT Filed: Jan. 28, 2022
(86) PCT No.: PCT/EP2022/052063

§ 371 Date: Jun. 14, 2024

(51) Int. Cl. G09F 3/20

(52) U.S. Cl. CPC G09F 3/208; G09F 3/204

(57) ABSTRACT

Electronic display device for displaying product and/or price information, which comprises: a housing that has a front wall (front-side surface), which has a screen, and a rear wall (rear-side surface), which is averted from the front wall, wherein the housing is designed to interact with a dimensionally stable coupling device for the purpose of coupling the electronic display device and an object, wherein the housing has a first coupling structure, which is fonned on its rear wall, wherein the first coupling structure is designed to re-releaseably hold or re-releasably fasten the coupling device, and wherein the first coupling structure is designed in such a way that the coupling is based on a transmission of force from the coupling device to the inner side of the rear wall.

### TECHNICAL FIELD

The invention relates to an electronic display device, which can be coupled to an object, for displaying product and/or price information.

### BACKGROUND

Today, in retail, electronic display devices are being used ever more frequently, particularly electronic shelf labels which are known by their English designation “Electronic Shelf Label”, ESL for short. The ESLs comprise a screen in order to display product and/or price information. The screen is frequently designed as an electrophoretic e-paper screen or reflective display in this case. These ESLs are usually fastened on shelving units, strictly speaking with the aid of the shelf edge strip thereof. For this, the ESLs comprise a coupling device which is adapted to the shelf edge strip. A coupling device of this type is known from WO 2017/153481 A1. Here, the ESL comprises an extendible pin for example, using which it can be coupled to the shelving unit which comprises corresponding recesses for accommodating the pin. This system has proven advantageous in order to fasten a multiplicity of ESLs to a certain type of shelving unit. In recent years however, electronic display devices have also become established in sectors in which not all products are presented on shelving units. Thus, in the case of furniture and furnishings retailers for example, products are presented in a very wide range of ways. The products here are no longer necessarily located in a shelving unit, but rather may also be located for example on tables or, if of a corresponding size, on the floor or else presented in a suspended manner. Hitherto, it was only possible, for such products, to convey the product or price information by means of paper-based labels.

Therefore, the object of the invention is to provide an electronic display device which can be used for a very wide range of types of product presentation.

### SUMMARY OF THE INVENTION

This object is achieved by an electronic display device for displaying product and/or price information according to claim 1. The subject matter of the invention is therefore an electronic display device for displaying product and/or price information, which comprises: a housing which comprises a front wall, which comprises a screen, and a rear wall, which faces away from the front wall, wherein the housing is designed for interacting with a dimensionally stable coupling device for the purpose of coupling the electronic display device and an object, wherein the housing comprises a first coupling structure which is formed on its rear wall, wherein the first coupling structure is designed for detachably holding or detachably fastening the coupling device, and wherein the first coupling structure is designed in such a manner that the coupling is based on force transfer from the coupling device to the inner side of the rear wall.

This object is further achieved by a coupling device according to claim 7. The invention therefore relates to a coupling device for coupling an electronic display device for displaying product and/or price information to an object, wherein the coupling device is designed in a dimensionally stable manner and wherein the coupling device comprises a second coupling structure which is designed for detachably holding or detachably fastening the electronic display device, and wherein the second coupling structure is designed in such a manner that the coupling is based on force transfer from the coupling device to an inner side of a rear wall of the electronic display device.

This object is further achieved by a coupling tool according to claim 17. The invention therefore relates to a coupling tool which is designed to fasten a coupling device according to the invention to an object or detach said coupling device from the same or fasten said coupling device to an electronic display device according to the invention or detach said coupling device from the same.

This object is further achieved by a fastening system, shortened to system, according to claim 18. The invention therefore relates to a system which comprises at least one electronic display device according to the invention and at least one coupling device according to the invention.

The measures according to the invention are associated with the advantage that the electronic display device can be used in various ways, because coupling to different objects is enabled. The measures according to the invention therefore provide a universally usable electronic display device for displaying product and/or price information.

The front wall is the front area or the front structure of the housing and the rear wall is the rear area or the rear structure of the housing.

The inner side of the rear wall here is the side of the rear wall which is directed towards the front wall. The normal vector of the surface (possibly described as smoothed), which is stretched over the inner side of the rear wall, is therefore directed to the greatest extent possible towards the front wall. If the electronic display device is observed from behind, the inner side of the rear wall is therefore hidden to the greatest extent possible.

The rear wall can be realized in one piece or in multiple parts. Thus, the inner side of the rear wall can also be formed from a plurality of parts.

Generally, the housing can be constructed in one piece or multiple parts, so the front wall and/or the rear wall can be formed from different or even a plurality of different housing parts or from only one housing part.

A dimensionally stable coupling device here is a coupling device which is sufficiently stable or flexurally rigid at least in some areas, particularly at its second coupling structure, in order to counteract a deformation as a consequence of its own weight in the event of a change of position to the greatest possible extent. In particular, the coupling device is sufficiently stable, at least in some regions, to transfer the forces and torques applied by the coupled electronic display device in a deformation-free manner to the greatest possible extent. Of course, however, deformations may be permitted or desired locally in order to realize snap mechanisms or spring mechanisms for example.

The coupling tool can be used to place the coupling device onto an object and couple the coupling device to the object or to decouple, that is to say to detach, the coupling device from this object. The coupling tool can however also be used to couple the coupling device to the electronic display device or to decouple the same. The coupling tool can be used to position the coupling device in a manner corresponding to an object and/or to an electronic display device, that is to say to place and align the coupling device exactly at a provided location. Therefore, the coupling tool is designed to grip or at least temporarily to hold the coupling device. The coupling tool can therefore be understood as a handling device for handling the coupling device.

Further particularly advantageous embodiments and developments of the invention result from the dependent claims and also the following description.

According to a further aspect of the invention, the coupling device comprises a third coupling structure which is designed to couple the coupling device to the object in a manner adapted to the object. This enables a simple and exactly positioned coupling of the electronic display device to the object by means of the coupling device. This emerges in an advantageous manner due to the adaptation of the third coupling structure to the object or the structural features thereof, to which the coupling device is connected or coupled, which is discussed in the following.

According to a preferred embodiment, the third coupling structure is designed to make a non-force-fitting and/or form-fitting connection to the object. This enables simple coupling on the one hand and again simple disconnection on the other hand at a later time.

It has been established as advantageous that the third coupling structure is designed to accommodate cords, cables, threads, wires or similar or that the third coupling structure itself is designed in a cord-like manner at least in some regions.

This enables the suspended fastening of the coupling device and subsequently the electronic display devices on objects, such as products, particularly furniture which is offered for sale. Thus, large products, such as beds or boxes, or products positioned in a suspended manner, such as ceiling lamps or picture frames for example, can be equipped, by means of the coupling device, with electronic display devices which hang on the products and make it possible for potential customers to obtain product and/or price information directly at the location of the product.

Due to the measures according to the invention, simple installation of the electronic display devices is also enabled in the case of suspended attachment. In a first work step, the coupling device can easily be fastened on the product without electronic display device. This step can therefore take place fast and with full focus on the positioning of the coupling device without having to take the sensitive electronic display device into account in the process. Subsequently, the coupling device can easily be held with one hand and coupled to the electronic display device which is located in the other hand. This coupling process can be carried out fast and, at the same time, reliably, so the freely suspended installation of a large number of electronic display devices is facilitated.

It has furthermore been established as advantageous that the third coupling structure is designed to grasp the object at least partially, particularly to be clamped or suspended on the object, or to spread with the object.

For this purpose, the third coupling structure for example comprises at least one clamp or a hook or a spreading device, using which the coupling device can be fastened on the object. This enables a simple and fast installation of the electronic display devices even in the case of confined spatial conditions, particularly on objects structured in a complex manner or objects which are rod- or bar-shaped at least in some regions, particularly preferably in a suspended manner on the bar-shaped structure.

The clampable connection makes it possible to attach the coupling device and therefore the electronic display device on multiplicity of objects, such as shelving units for example, or products, such as plants which are offered for sale for example. Thus, the coupling device can be clamped to the stem of a plant or to the front edge of a shelf or even a basket.

As explained previously, the coupling device can also here be placed in a first step and subsequently coupled to the electronic display device in a second step. In addition to the time and economic factor, there is also the enablement of the attachment of the electronic display device at places with little space available, because the coupling device can for the most part easily be attached alone, wherein this can subsequently easily be coupled to the electronic display device, so that the electronic display device is reliably located at the desired place after the coupling process, particularly with the orientation defined by the coupling device.

Such a coupling device has been established as exceptionally helpful in particular for coupling to baskets of goods or basket-like shelving units, because it enables simple attachment of the electronic display devices even in the case of such multipartite and often complexly shaped objects.

According to a preferred embodiment, the third coupling structure is designed to undergo an adhesive connection to the object, in particular the third coupling structure comprises an adhesive layer or is designed as an adhesive layer. This enables a precise placement of the electronic display device on an object. As also in the case of the previously explained measures, the coupling device can here first be adhesively connected to the object before the coupling device is coupled to the electronic display device. This type of coupling is suitable in particular on objects comprising flat or planar structures.

The previously mentioned advantages also come to bear here, so fast installation is possible even in the case of a small space requirement.

In addition, this bipartite system made up of electronic display device and adhesive coupling device facilitates detaching the adhesive connection again after successful presentation of the product and/or price information, that is to say when the electronic display device is no longer required at its current position. For this, the electronic display device can be decoupled from the coupling device, so that the coupling device becomes accessible. After that, the coupling device can be gripped and disconnected from the object again. This can take place in a different way, depending on the adhesive. Thus, a rotational movement can be carried out for example to detach the adhesive.

Preferably, an adhesive is therefore used, which can be detached under a certain form of loading, for example in the case of a rotational movement or in the case of tensile loading in a defined direction. Such an adhesive is for example known under the name tesa Powerstrips® and is sold by the company tesa SE. Such an adhesive provides a good adhesive connection after proper placement (for example a load-bearing capacity of up to 2 kg, with an adhesive strip 2 cm by 5 cm large with vertical mounting) and can be detached easily at the same time by tensile loading in the direction of its longitudinal extent.

Such an adhesive connection can be detached particularly well using the coupling tool explained in the introduction. For this, the coupling tool can grip the coupling device and carry out the corresponding movement or loading in order to detach the adhesive connection. That is to say for example, pull or rotate the coupling device in a certain direction, so that the adhesive connection is detached from the object.

In order to enable gripping that is as optimal as possible, it has been established as advantageous that the coupling device comprises a coupling-tool receptacle which is designed to accommodate the coupling tool in order to exert force transfer to the coupling device.

As explained, this is particularly advantageous in the case of coupling devices which are designed for realizing an adhesive connection, in order to detach the adhesive connection from the object.

However, also in the case of other coupling devices, the coupling process, that is to say the coupling of the coupling device to the object and/or to the electronic display device, and the decoupling process, that is to say the decoupling or disconnection of the coupling device from the object and/or from the electronic display device, can be facilitated or optimized by the coupling tool and corresponding coupling-tool receptacles.

Preferably, the aforementioned coupling tool is therefore a constituent of the system.

In addition to the previously explained embodiments of the third coupling structure of the coupling device, further embodiments are of course possible.

Thus, the third coupling structure can be designed as a magnet or comprise a magnet in order to undergo a magnetic-force-based coupling to a magnetic or magnetizable object.

The embodiments of the third coupling structure explained here can of course also be combined. Thus, the third coupling structure can for example comprise a cable which comprises a clamp at one end, using which it can be clamped to the object.

The coupling between electronic display device and coupling device can take place substantially independently of the choice of the third coupling structure. In particular, the electronic display device can be designed to be coupled to different coupling devices, that is to say coupling devices with different third coupling structures.

The coupling between the electronic display device and the coupling device is explained further in the following.

The system or the coupling device and the electronic display device can be designed for magnetic-force-based coupling.

For this, the second coupling structure of the coupling device and the first coupling structure of the electronic display device comprises either a magnetic material or a magnetizable material, wherein at least the first coupling structure or the second coupling structure comprises a magnetic material. The magnetic or the magnetizable material of the first coupling structure can here be located in the interior of the electronic display device for example and bear against the inner side of the rear wall there.

The coupling device can for example comprise a second coupling structure which consists of a magnetic or magnetizable material and is formed in a flat manner, so that this coupling structure can be laid flat onto the rear side of the electronic display device.

If the second coupling structure of such a magnetic-force-based coupling device is brought to the rear wall in the surroundings of the first coupling structure of the electronic display device, a coupling is created as a consequence of the magnetic force which acts, by means of the first and second coupling structures, on the inner side of the rear wall.

The second coupling structure can be designed as a flat circular ring shape. This has been established as advantageous, because an exact placement of the coupling device relative to the electronic display device is possible in this manner and because simple coupling of the coupling device to the object is possible at the same time. To realize the coupling to the object, a cord (or a plurality of cords) for example can be pushed through the circular ring so that the coupling device can be connected or coupled to an object in a suspended manner. The circular ring therefore also in this case forms the third coupling structure with its recess, by which the cords are accommodated.

The coupling to the further object can likewise take place by means of magnetic force, so that the coupling element can for example be realized as a flat magnet and thus can be fastened on an object, for example a sheet-metal structure of a shelving unit, whereupon the electronic display device can be coupled to the coupling device.

According to one aspect of the invention, at least one part of the rear wall of the electronic display device is designed, as a constituent of the first coupling structure, such that it is possible to engage behind it. In particular, the rear wall of the electronic display device is designed such that it is possible to engage behind it by means of the coupling device. This enables a stable mechanical coupling between the coupling device and the electronic display device.

Here, it is possible to engage behind it means that the rear wall of the electronic display device is designed in such a manner that the coupling device adapted therefor can be moved behind the rear wall in order to contact the inner side of the rear wall there. If the coupling device has engaged behind the rear wall, a mechanical force transfer results between the inner side of the rear wall and the coupling device to provide the coupling.

The rear wall, at the point where it is possible to engage behind it, here forms part of the first coupling structure.

The second coupling structure of the coupling device is in particular designed in such a manner to engage behind the rear wall of the electronic display device.

The electronic display device and the coupling device are therefore preferably designed such that they can be inserted into one another or removed from one another. Particularly preferably, the coupling device is designed such that it can be inserted into the electronic display device.

For this, the coupling device or its second coupling structure can comprise a snap connection for example. This snap connection can be realized as a snap hook of flat construction. The rear wall of the electronic display device can accordingly comprise a bridge-like structure as first coupling structure, through which the snap hook can be moved when the second coupling structure is moved parallel to the recess of the rear wall along the same. The snap hook can thus engage behind the rear wall through the bridge-like structure and get caught at the other end of the bridge-like structure. In the coupled state, the snap hook is therefore passed through the bridge-like structure and contacts the same on the inner side of the bridge-like structure, that is to say on the inner side of the rear wall.

The rear wall can be recessed in the region in which the coupling device is inserted, so that the rear wall and the coupling device in the coupled state form a substantially uniform surface. This enables a better placement and makes the placement option more flexible, because the space at the rear wall can be used ideally in this manner.

It has therefore generally been established as advantageous that the first coupling structure comprises a coupling indentation or coupling recess in the region where it is possible to engage behind the rear wall, which coupling indentation or coupling recess is designed for accommodating the coupling device. This makes it possible, as in the previously mentioned embodiment, but also very generally, to provide a compact coupling between coupling device and electronic display device.

Of course, the first coupling structure can also comprise a coupling indentation which is designed for accommodating the coupling device. Such a coupling indentation can for example comprise a mushroom-like shape, wherein the rear wall comprises a rearwardly or outwardly directed hat-like structure which is connected to the rest of the housing by means of a stem-like structure, so that it is possible for the coupling device to access and engage behind the inner side of the rear wall under the hat-like structure. Accordingly, the second coupling structure of the coupling device is designed to surround the hat-like structure and engage behind the inner side of the rear wall, that is to say the side which is covered by the hat-like structure. A coupling indentation can be advantageous in particular if it is desired to move the display device further forwards from the coupling point. This can be used for example to position the product and/or price information more in the space which attracts attention to it.

However, it is often desirable to keep the display device and the components used for the assembly as compact as possible in order to make optimum use of the available space that is available for presenting the product and the electronic display device. The coupling indentation or the coupling recess are advantageous for this in particular, because part of the coupling device can be introduced into the electronic display device therewith and therefore the accommodated part of the coupling device is accommodated inside the display device in a space-saving manner.

Furthermore, it has been established as advantageous that the first coupling structure is formed by the inner side of the rear wall at least in some regions.

Accordingly, it is advantageous that the second coupling structure is designed in a substantially extensive or disc-like or plate-like manner.

These measures enable a compact and at the same time secure coupling. For this, the coupling device is preferably designed in such a manner that the extensive second coupling structure of the coupling device engages behind and thus mechanically contacts the extensive inner side of the rear wall, that is to say the force transfer at the inner side of the rear wall takes place.

It has been established as particularly advantageous in this context that the first coupling structure comprises an accommodating groove or an accommodating slot located inside the electronic display device for accommodating the coupling device. This enables an optimum engagement behind the rear wall using the second coupling structure of the coupling device and therefore an optimum force transfer to the inner side of the rear wall. This measure therefore provides a secure mechanical coupling.

The accommodating groove or the accommodating slot preferably runs in such a manner here that a first side wall of the accommodating groove or the accommodating slot forms the inner side of the rear wall. Outwardly, the accommodating groove is therefore delimited by the inner side of the rear wall.

The peripheral shape of the accommodating groove, which runs below the rear wall (that is to say in the interior of the display device) substantially parallel to the rear wall, can be polygonal for example, such as square or rectangular. Particularly preferably, the peripheral direction has a circular shape however.

The depth of the coupling indentation or coupling recess is defined by a delimiting wall. This delimiting wall runs parallel to the inner side of the rear wall. Preferably, however, a second side wall of the accommodating groove delimits the depth of the coupling indentation or coupling recess inwardly. The second side wall of the accommodating groove preferably also runs parallel to the inner side of the rear wall where engagement behind the rear wall takes place.

The accommodating groove is delimited by an edge wall along the peripheral shape of the accommodating groove. The walls of the accommodating groove delimit the extent thereof and at the same time protect the interior of the display device from contaminants.

Particularly in combination with a coupling device as described in the following, a particularly fast and simple coupling can therefore be realized.

It is advantageous that the second coupling structure has a prismatic shape or a prismatic shape comprising rounded and/or milled corners and/or edges, preferably has a rotationally symmetrical base area, particularly preferably the base area corresponds to a regular polygon, particularly a square.

The first coupling structure comprises a coupling recess or coupling indentation which is adapted to the base area of the second coupling structure of the coupling device and which makes insertion or passage of the second coupling structure through the coupling recess or coupling indentation readily possible.

The first coupling structure therefore preferably comprises a prismatically shaped recess or a prismatically shaped recess with rounded and/or milled corners and/or edges, the shape of which is configured such that the second coupling structure can readily be inserted into the housing.

The accommodating groove or an accommodating slot is, as explained, designed to accommodate the second coupling structure, which is inserted into the first coupling structure, so that contacting of the inner side of the rear wall by the second coupling structure and force transfer to the inner side of the rear wall results.

These measures enable coupling by simple plugging of the second coupling structure into the first coupling structure and subsequent movement of the two structures towards one another to fix the coupling.

Due to the rotationally symmetrical base area, the electronic display device and the coupling devices can be coupled or positioned in different alignments relatively to one another, which makes different placement options available. Particularly in the case of a square base area, the electronic display device and the coupling devices can be plugged into one another in four different orientations. An employee who would like to couple the electronic coupling device to an object can therefore easily align and attach the coupling device on the object, whereupon they can connect the electronic display device to the coupling device in four different orientations. Thus, they can choose a corresponding orientation depending on the format of the presented product and/or price information for example, wherein in the case of a square base area of the second coupling structure, the alignment of two adjacent orientations are substantially at right angles to one another.

Of course, other shapes are also possible, thus a mirror-symmetrical base area, such as a rectangular base area for example, enables plugging into one another in two positions.

As explained, the coupling after plugging into one another is fixed by a movement of the electronic display device with respect to the coupling device. Such a movement can for example be a linear movement of the coupling device along the rear wall of the electronic display device, which is enabled e.g. by a correspondingly large extent of the opening in the rear wall or a slot or channel in the rear wall in the direction of the linear movement to be completed. It has proven particularly preferable if the coupling can be fixed by a rotational movement.

To enable the rotational movement, the first coupling structure of the electronic display is preferably designed and adapted to the coupling device in such a manner that the electronic display device and the coupling device can be plugged into one another, wherein the first coupling structure is designed in such a manner that the coupling device in the plugged-in state can be rotated into a holding position. The first coupling structure is therefore structurally formed by the constituents of the display device which on the one hand enable the introduction of the coupling device into the housing of the display device and on the other hand allow the rotation of the second coupling structure, which rotation engages behind the rear wall, and consequently permit the force transfer to the region of the rear wall behind which engagement takes place. This structure is substantially formed by an accommodating shaft for accommodating a part of the coupling device, wherein the accommodating shaft comprises at least one accommodating groove running along the inner side of the rear wall there in some regions, which accommodating groove permits the rotation of the coupling device out of its position, where it is inserted into the accommodating shaft, into a holding position.

Furthermore, to enable the rotational movement, the second coupling structure of the coupling device is preferably designed and adapted to the electronic display device in such a manner that the electronic display device and the coupling device can be plugged into one another, wherein the second coupling structure is designed in such a manner that the coupling device in the plugged-in state can be rotated into the holding position.

The rotatability of the electronic display device compared to the coupling device substantially results in that the accommodating groove or the accommodating slot is configured in such a manner along the inner side of the rear wall that the second coupling structure can slide unhindered along the inner side of the rear wall at least in some regions. This can be achieved for example in that the shape of the accommodating groove is circular for example and the diameter of the circle is dimensioned slightly larger than the diagonal of the second coupling structure.

Furthermore, the coupling device for providing the rotatability comprises a shaft or stem which attaches to the second coupling structure and which is dimensioned such with regards to its thickness (diameter) that it does not hinder the rotational movement. The thickness of the shaft or stem is therefore smaller than the smallest dimension of the opening of the rear wall, through which the second coupling structure can be inserted into the display device. The length of the shaft or stem is minimally dimensioned such that the part of the coupling device necessary for coupling to the object can be positioned outside the rear wall.

In the holding position, the electronic display device and the coupling device cannot be separated from one another, but can be rotated relative to one another until they assume a removal position or insertion position, which is different from the holding position, in which they can be removed from one another again.

According to an optional aspect, the first coupling structure and the second coupling structure can be adapted to one another in such a manner that in the holding position, owing to the surface pressure, an undesired back rotation is prevented. Alternatively, a spring or a resilient element can of course also be used here, which presses the second coupling structure onto the inner side of the rear wall. Also, the inner side of the rear wall can comprise a corresponding slope or a corresponding course, so that the fixing in the holding position is ensured or at least assisted. Also, bolts or screws or threads can be used in order to ensure the fixing in the holding position. However, because this lengthens or complicates the coupling process, it has been established as advantageous that the coupling device and the electronic display device are designed such that they can be coupled in a bolt-free or screw-free or thread-free manner.

The electronic display device and the coupling device are therefore designed to be coupled by means of plugging into one another and opposite rotation.

According to a preferred embodiment, the second coupling structure of the coupling device is therefore designed in an extensive or disc-like or plate-like manner and has a prismatic shape comprising rounded edges with a square base area. The first coupling structure of the electronic display device therefore has the same area shape as the edge of the coupling indentation or coupling recess in the rear wall, so that the second coupling structure can be introduced there. The area of this opening in the rear wall is somewhat larger than the base area of the second coupling structure however, in order not to hinder the second coupling structure during the introduction of the same.

As mentioned, the coupling indentation or coupling recess comprises the delimiting wall. The delimiting wall runs parallel to the rear wall to the greatest extent possible. The accommodating groove runs between the delimiting wall and rear wall. The one side wall of the accommodating groove forms the delimiting wall, the other side wall of the accommodating groove forms the inner side of the rear wall. The width of the accommodating groove, that is to say the distance between the delimiting wall and the inner side of the rear wall, corresponds to the depth of the second coupling structure which is designed in an extensive or disc-like or plate-like manner. The accommodating groove follows a circular line around the centre of the first coupling structure or around the centre point of the base area. The diameter of this circle corresponds to the diagonal between two rounded corners of the coupling indentation or coupling recess.

In order then to couple the electronic display device to an object, the coupling device is here coupled to an object by means of the third coupling structure, wherein the third coupling structure can differ depending on the object, as explained, or a coupling device comprising the corresponding third coupling structure, which fits the object, can be chosen. Then, the electronic display device can be guided to the coupling device so that the second coupling structure penetrates into the coupling indentation or coupling recess until the second coupling structure is positioned at the delimiting wall. In this position, the electronic display device is still offset by 45° with respect to the desired holding position. Then, the electronic display device can be rotated, with which the second coupling structure moves into the accommodating groove between delimiting wall and inner side of the rear wall and takes up contact with the same. Because the groove width (this is the distance between the side walls of the accommodating groove) and the depth of the second coupling structure are adapted to one another, a surface pressure prevails between the contact points. After a rotation of 45°, the maximum contact surface between first coupling structure and second coupling structure is produced and the holding position is reached. The second coupling structure contacts the inner side of the rear wall, so that coupling is ensured as a consequence of the force transfer of the coupling device to the inner side of the rear wall.

Due to the free rotatability of the electronic display with respect to the coupling device, a fine adjustment of the display device with respect to the present orientation of the coupling device can even be carried out. This is important in particular if the fastening of the coupling device on the object does not permit any flexibility. For fine adjustment, the electronic display device merely has to be rotated somewhat with respect to the coupling device. The electronic display device and the coupling device are then located in a holding position which deviates somewhat from the 45° related to the insertion position.

If, in the course of time, the display device is no longer required at its current position, because for example the object is no longer being presented, the electronic display device can easily be rotated with respect to the coupling device until the electronic display device can be disconnected or the coupling device can be removed. Then, the electronic display device can easily be mounted to a different coupling device on a different object or coupled to a different object.

The measures according to the invention therefore enable a system which comprises the electronic display device and at least two different coupling devices which differ from one another in terms of the third coupling structure thereof and wherein the two different coupling devices can optionally be coupled to the electronic display device. This is made possible by the identical design of the second coupling structure of the two coupling devices.

Furthermore, it has been established as advantageous that the first coupling structure is located centrally in the rear wall of the electronic display device, that is to say at the centre of the rear wall. Therefore, a low-torque or even torque-free attachment of the electronic display device on the object is possible. This simplifies the attachment at the object, because the electronic display device does not tend to rotate due to its own weight.

The coupling device is preferably dimensioned in such a manner that the coupling device, when it is coupled to the display device and is located in the holding position, can be hidden to the greatest extent possible, particularly completely, by the electronic display device. The display device therefore hides the coupling device, which inspires the appearance for the observer as if the display device were attached directly at the object.

Preferably, the coupling device is designed to couple only exactly one electronic display device at the same time. This furthermore improves the flexibility in the placement of the electronic display devices within a sales area.

Preferably, the coupling of the coupling device to the electronic display device takes place in a thread-free and/or bolt-free manner. Furthermore, the coupling of the coupling device to the object preferably takes place in a thread-free and/or bolt-free manner. As a result, particularly fast and therefore efficient coupling processes by means of employees of a business are possible, particularly without additional connecting means such as bolts or threaded rods and the like.

Preferably, the third coupling structure is dimensioned in such a manner that in the coupled state—in which the coupling device is coupled to the electronic display device—it is completely hidden by the electronic display device if the screen of the electronic display device is viewed from the front. Here, the coupled state is the state in which the holding position is achieved. For this, the extents or dimensions of the third coupling structure are dimensioned smaller than or at most the same size as the corresponding extent of the corresponding electronic display device.

Furthermore, it is advantageous that the third coupling structure is designed in a substantially plate-shaped manner. This enables a space-saving connection of the coupling device to the object and therefore a space-saving coupling between the electronic display device and the object. The substantially plate-shaped design does not exclude bores or holes and the like from being located in the third coupling structure or else fastening tabs or clamps are present, which protrude from the plane.

Finally, it may also be explained in general that the explained electronic display device of course comprises electronics. The electronics can be discrete or consist of integrated electronics or else consist of a combination of both. Also, microcomputers, microcontrollers, application specific integrated circuits (ASICs), can possibly be used in combination with analogue or digital electronic peripheral components. Many of the functionalities of the display device are realized—possibly interacting with hardware components—with the aid of software which is executed on a processor of the electronics. Display devices which are designed for radio communication usually comprise an antenna configuration as a constituent of a transceiver module for transmitting and receiving radio signals. The electronic display device can additionally comprise an internal electrical power supply which can be realized with a replaceable or rechargeable battery for example. Also, the display device can be supplied in a wired manner, either by an external power supply unit or else by means of “Power over LAN”.

These and further aspects of the invention emerge from the figures which are discussed below.

### BRIEF DESCRIPTION OF THE FIGURES

The invention is explained once more in detail in the following with reference to the attached figures with reference to exemplary embodiments, to which the invention is not restricted, however. In the various figures, identical components are provided with identical reference numbers. In the figures, in a schematic manner:

FIG. 1 shows a rear view of an electronic display device comprising a first coupling structure for coupling to a coupling device;

FIG. 2 shows the electronic display device with an inserted coupling device which comprises an adhesive film;

FIG. 3 shows a coupling tool for coupling the coupling device according to FIG. 2 on the electronic display device;

FIGS. 4A-4E show the handling of the electronic display device and the coupling device according to FIG. 2;

FIG. 5 shows an embodiment of the coupling device which is designed to be clamped to an object;

FIGS. 6A-6B show various views of a display device which is clamped to a basket-like shelving unit and which is clamped to the shelving unit with the aid of the coupling device according to FIG. 5;

FIGS. 7A-7E show various views of a further embodiment of the coupling device for suspended coupling of the electronic display device;

FIG. 8 shows an electronic display device suspended on an object;

FIGS. 9-11 show a further exemplary embodiment of the electronic display device and corresponding coupling devices.

### DESCRIPTION OF THE EXEMPLARY EMBODIMENTS

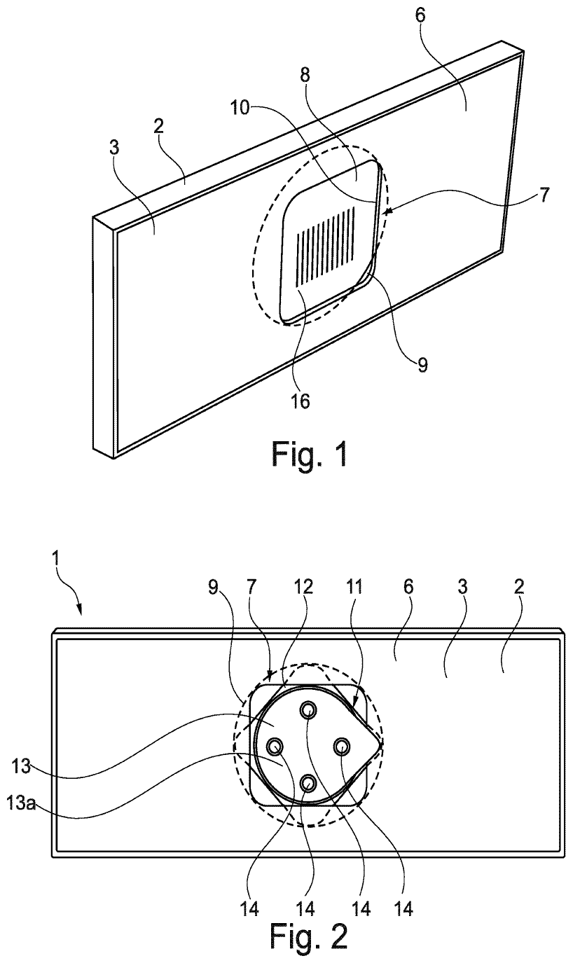

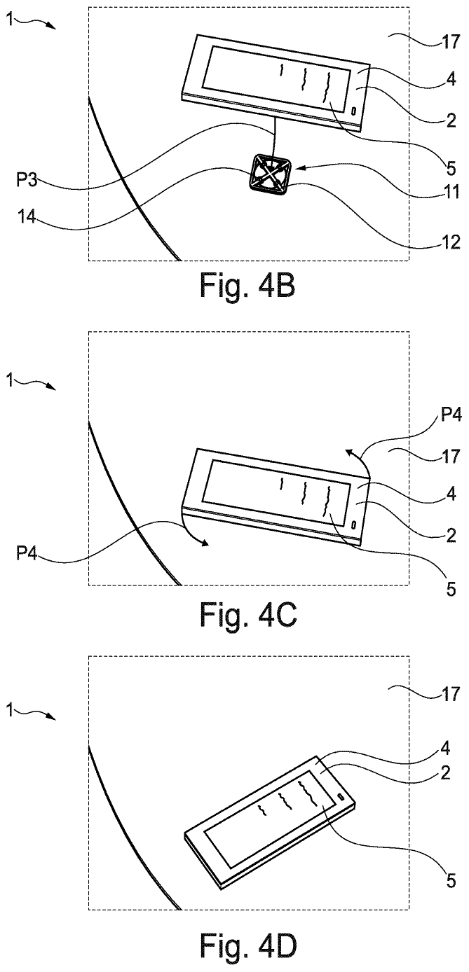

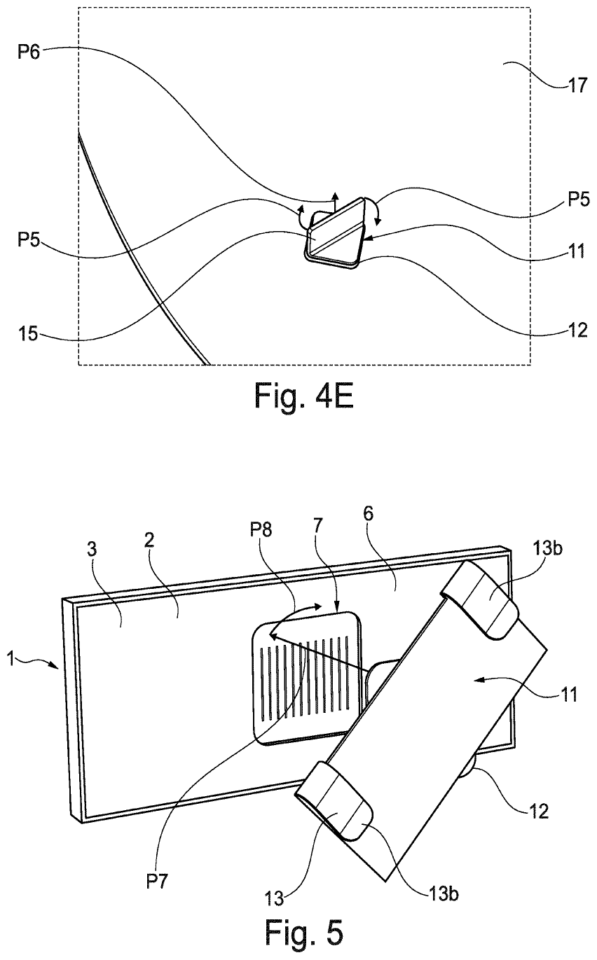

FIG. 1 shows an electronic display device 2 with a view of a rear wall 3 of a housing 6 of the electronic display device 2. On the side of the electronic display device 2 facing away from the rear wall 3 there is the front wall 4 which comprises the screen 5 (to be seen in FIGS. 4B to 4D) which is provided for displaying product and/or price information. The rear wall 3 is located on the rear side of the electronic display device 2. The front wall 4 is located on the front side of the electronic display device 2. The front side runs parallel to the screen 5, the rear side runs parallel to the front side.

The rear wall 3 centrally comprises a first coupling structure 7 comprising a coupling recess. The shape of the coupling recess in the rear wall 3 is approximately square with rounded corners. The first coupling structure 7 comprises a delimiting wall 8 which delimits the coupling recess towards the interior of the display device and which runs extensively parallel to the rear wall 3. The delimiting wall 8 delimits the path from the rear wall 3 into the electronic display device 2 in the direction of the front wall 4. An accommodating groove 9 runs between rear wall 3 and delimiting wall 8, from which a small edge region can be seen. The accommodating groove 9 runs as a circular circumferential groove around the entire circumference of the coupling recess. The circumference of the circle which the accommodating groove 9 of the first coupling structure 7 follows is indicated dashed here. The diameter of the circumference of the accommodating groove 9 here corresponds to the diagonal of the substantially square base area of the coupling recess. The accommodating groove 9 is therefore delimited in the axial direction, that is to say normal to the rear wall 3 or normal to the delimiting wall 8, on one side by the delimiting wall 8 and on the other side by the inner side 10 of the rear wall 3. The inner side 10 of the rear wall 3 here is the side of the rear wall 3 that is hidden by the rear wall 3 when observing the display device in FIG. 1, that is to say is not visible.

The first coupling structure 7 is therefore designed to accommodate a second coupling structure 12 of a coupling device 11, in order to provide a coupling between electronic display device 2 and coupling device 11, wherein the second coupling structure 12 of the coupling device 11 engages behind the rear wall 3 of the electronic display device 2 when the coupling device 11 is inserted into the coupling recess and the coupling device 11 is rotated into the holding position, as is visualized in FIG. 2.

A machine-readable code is located on the delimiting wall 8, specifically a bar code 16, which enables the automatic detection of the ESL by means of a code scanning device, for example by means of a mobile telephone comprising a corresponding application, in order to depict the connection of the electronic display device 2 to a product in a database.

FIG. 2 shows a system 1 for coupling the electronic display device 2 to an object (not illustrated), which has the electronic display device 2 and the coupling device 11.

The second coupling structure 12 is designed as a flat prism with rounded edges. The prism has a square as base area. The second coupling structure 12 is adapted in terms of its shape and its dimensions to the first coupling structure 7. The first coupling structure 7 and the second coupling structure 12 are therefore designed such that they are adapted to one another in such a manner that the electronic display device 2 and the coupling device 11 or the first coupling structure 7 and the second coupling structure 12 can be plugged into one another and that the coupling device 11 in the plugged-in state can be rotated with respect to the electronic display device 2 into the holding position. The holding position here is the position at which the (rounded) edge of the second coupling structure 12 is located exactly between two (rounded) edges of the coupling recess. Therefore, there are four holding positions here, so the electronic display device 2 can be placed in four different orientations, for example depending on the product and price information presented on the screen. The electronic display device 2 and the coupling device 11 can c therefore be coupled to one another by means of plugging into one another and rotation with respect to one another (wherein one of the objects can also be fixed for this however). During rotation in the plugged-in state, the plate-shaped second coupling structure 12 engages behind the rear wall 2. The first coupling structure 7 and the second coupling structure 12 therefore realize a coupling mechanism which is realized similarly to a bayonet closure or in a bayonet-closure-like manner. Unlike in the case of classic bayonet closures, this exemplary embodiment manages without a spring however and a thread-like groove is omitted, which in classic bayonet closures fixes the holding position under the action of the spring. Instead, in this exemplary embodiment, the holding position is fixed in that the depth or thickness of the second coupling structure 12 and the groove width of the accommodating groove 9 of the first coupling structure 7 are adapted to one another in such a manner that the holding position is held as a consequence of the surface pressure between first coupling structure 7 and second coupling structure 12. The dimensions in the direction of the groove width are therefore adapted to one another in the sense of a press fit. This has the advantage with respect to the classic bayonet closure that angle errors can be compensated, because positions around the holding position can also be assumed in a flexible manner.

Of course, precisely the explained measures of a classic bayonet closure can be used to fix the holding position. Thus, the accommodating groove 9 can comprise a slope in places and a spring can be provided, which presses the second coupling structure 12 against the inner side 10 of the rear wall 3 for coupling the electronic display device 2 to the coupling device 11, so that the second coupling structure moves into the holding position following the slope. The spring can be attached to the delimiting wall 8 for this.

The coupling device 11 in the exemplary embodiment shown here comprises a third coupling structure 13 for coupling the coupling device 11 to an object. The third coupling structure 13 is realized here for coupling to an object by means of adhesive connection. For this, the coupling structure 13 comprises an adhesive film 13a, using which the coupling device 11 can be adhesively bonded to (particularly flat) objects, as is also explained in the following. Furthermore, a protective film is provided, which protects the adhesive film 13a from contamination. In order to adhesively bond the adhesive film 13a to an object, the protective film must be pulled off in advance.

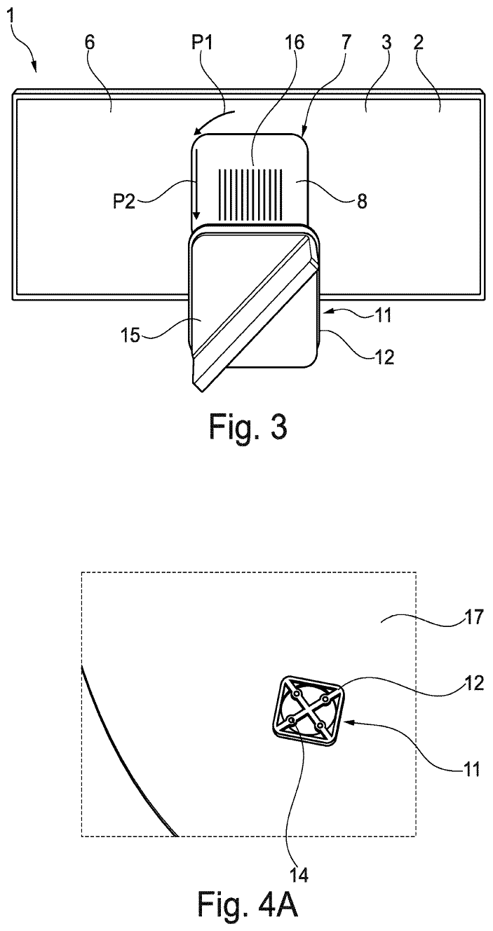

Furthermore, the coupling device 11 comprises a coupling tool receptacle 14 for accommodating a coupling tool 15 (see also FIG. 3). The coupling tool receptacle 14 is realized by means of four circular bores. The coupling tool 15 comprises four pins adapted thereto, the dimensions of which pins are adapted to the coupling tool receptacle 14 in such a manner that the pins can be introduced into the bores. Furthermore, the coupling tool 15 comprises a flat bearing surface, on which the coupling device can rest when the pins are introduced into the bores. The coupling tool 15 can be introduced into the coupling tool receptacle 14 in both directions here. The pins can therefore be introduced in both directions along the axes of the bores. Thus, the coupling tool 15 can both be used for coupling the coupling device 11 to the electronic display device 2 and to couple the coupling device 11 to an object. Furthermore, the coupling tool 15 comprises a handle to enable simple gripping of the coupling tool 15.

With respect to FIG. 3 and the following figures, it may be mentioned that the delimitation of the accommodating groove 9, which is indicated with a dashed line, is no longer drawn in for reasons of clarity.

FIG. 3 shows the coupling tool 15 during removal of the coupling device 11. For this, the pins of the coupling tool 15 were plugged into the bores of the coupling tool receptacle 14 and the coupling device 11 was rotated out of its holding position until the second coupling structure 12 is removable through the opening in the rear wall. This rotational movement by approx. 45° parallel to plane of the rear wall 2 is visualized with an arrow P1. Subsequently, the coupling device 11 was removed from the electronic display device 2, normal to the delimiting wall 8, away from the same. This movement, which is translational to the greatest extent possible, is indicated by an arrow P2. A renewed insertion would accordingly take place in the reverse sequence, wherein a rotational movement in the direction of the arrow P1 would also lead to a holding position.

Then, in order to couple the coupling device 11 to an object, the coupling device 11 is first taken off the coupling tool 15 and turned round before it is again placed onto the coupling tool in the turned state. The third coupling structure 13 or the adhesive film 13a is then directed away from the coupling tool 15. Then, the protective film can be pulled off and the coupling device 11 with the coupling tool 15 can be placed onto an object. For this, the coupling device 11 can be pressed against the object by means of the coupling tool 15 in order to produce an adhesive connection which is as optimal as possible. For this, the pins of the coupling tool 15 are designed to be shorter than the depth of the bores, so that the adhesive layer or the adhesive film 13a can be pressed onto the object over the whole area by means of the coupling tool 15.

FIG. 4A shows the coupling device 11 which is then placed on the object. The object here is a table 17 which is offered as a product for sale.

As illustrated in FIG. 4B, the electronic display device 2 is then placed for coupling to the coupling device 11 and as a result for coupling to the table 17 by means of the coupling device 11, so that the first coupling structure 7 can be introduced through the opening of the rear wall 3 into the coupling recess until the coupling device 11 is positioned at the delimiting wall 8. This position is reached in FIG. 4C. The described movement is visualized by means of an arrow P3.

As illustrated in FIG. 4C, the electronic display device 2 can then be rotated with respect to the coupling device 11 until the holding position is reached. This corresponds to a rotation by 45°. This rotational movement by approx. 45° is illustrated with two arrows P4.

The holding position is reached in FIG. 4D. In this position, potential customers can simultaneously look at the product, that is to say the table 17, and the product and price information presented on the screen 5 from an intended perspective.

If the electronic display device 2 is no longer required on this product 17, because the product is replaced by a new range for example, the previously explained steps can simply be run through in reverse sequence in order to disconnect the electronic display device 2 from the coupling device 11.

As shown in FIG. 4E, the coupling device 11 can then also easily be disconnected from the table 17 using the coupling tool 15. For this, the coupling device 11 is gripped using the coupling tool 15 and removed from the table 17 using a rotating movement that lifts away on one side. This rotational movement is visualized with arrows P5. As indicated with the aid of an arrow P6, after the adhesive layer 13a had been separated from the table 17 by means of a rotational movement, the coupling tool 15 together with the coupling device 11 can be removed from the table.

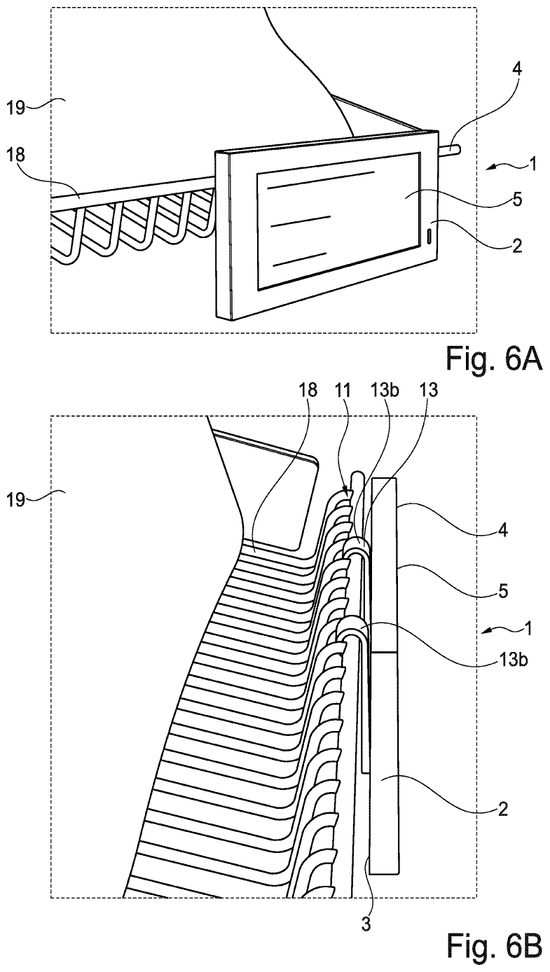

As FIG. 5 visualizes, the electronic display device 2, which has been released in this manner, can then be connected to a further coupling device 11 in order to be coupled to a different object using the same. The coupling device 11 in this exemplary embodiment is a coupling device 11 which comprises a third coupling structure 13 which is designed to clamp to an object. For this, the third coupling structure 13 comprises two clamps 13b. In the present case, these are two flexible wing-like clamps 13b which are particularly well suited for fastening to rod- or bar-shaped objects. For this, the clamps 13b can encompass the rod- or bar-shaped objects so that a non-positive and/or a positive connection occurs, depending on the size.

This coupling device 11 also comprises the previously explained second coupling structure 12 for connecting the coupling device 11 to the electronic display 2. This must likewise be introduced into the coupling recess (as an arrow P7 shows) and rotated into the holding position (as an arrow P8 shows) in order to produce the connection. Because the coupling device 11 illustrated here can be gripped well, it is possible in the present case to dispense with the coupling tool 15, which is why the coupling device 11 in this exemplary embodiment also does not comprise a coupling tool receptacle 14. The release of the coupling takes place in the reverse sequence of the explained actions.

FIGS. 6A and 6B show the system 1 consisting of the electronic display device 2 and the coupling device 11, which comprises the two clamps 13b. The electronic display device 2 is coupled by means of the coupling device 11 to a basket-like shelving unit 18, wherein the two clamps 13b encompass the frontmost shelving unit bar from above. A pillow 19 is lying in the shelving unit 18, which pillow is offered as a product for sale. Product and/or price information about the pillow 19 are displayed on the screen 5.

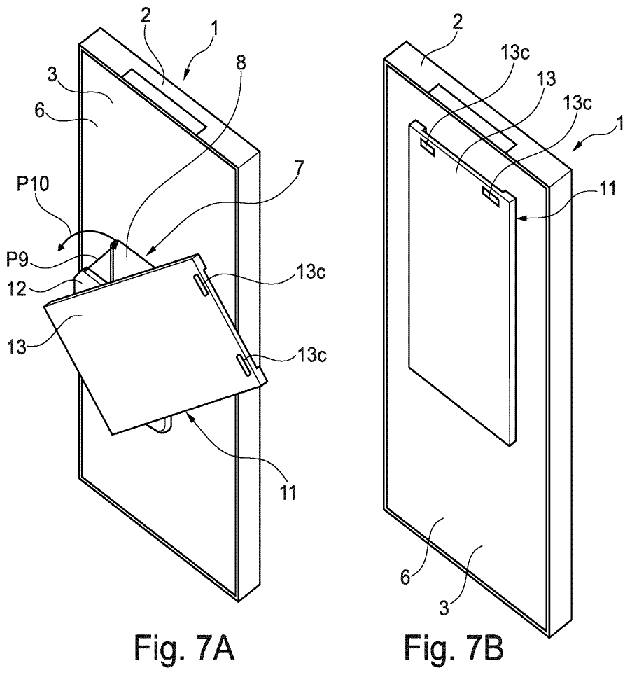

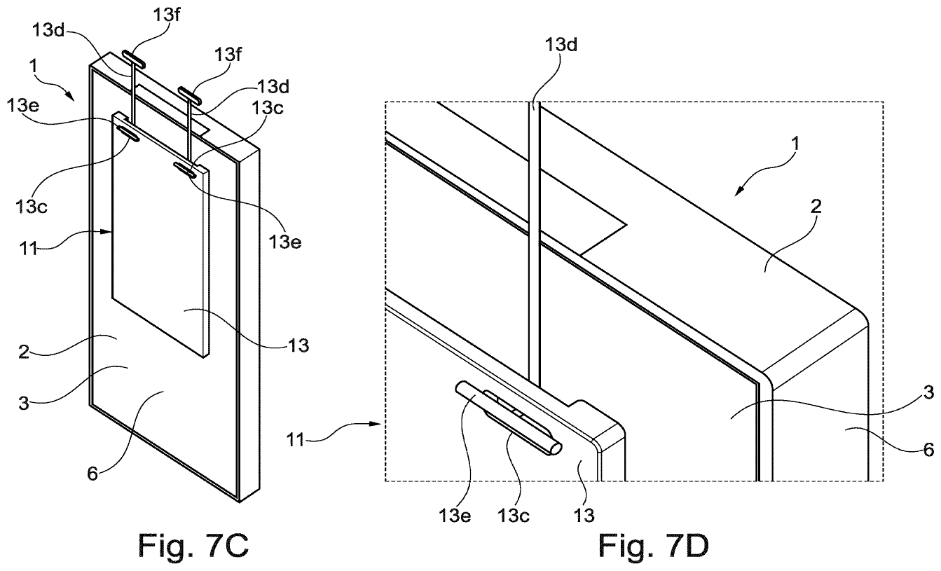

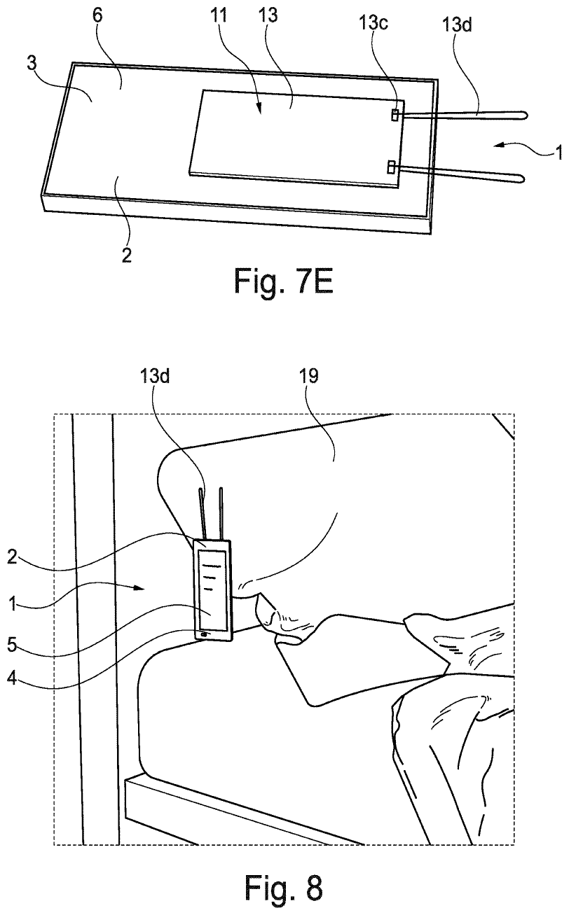

As illustrated in FIGS. 7A to 7D, the coupling device 11 can be designed to provide a freely-suspended attachment of the electronic display device 2. For this, the third coupling structure 13 is designed to accommodate cords 13d by means of eyelets 13c. Using the cords 13d, the coupling device 11 and therefore also the electronic display device 2 can be suspended on an object and dangle freely there, as is visualized in FIG. 8.

FIGS. 7A and 7B here show the coupling process between coupling device 11 and electronic display device 2. In FIG. 7A, the base area of the second coupling structure 12 of the coupling device 11 is positioned parallel to the coupling recess of the first coupling structure 7. The second coupling structure 12 can therefore be inserted into the first coupling structure 7 by means of a translational movement towards the electronic display device 2 through the coupling recess, as is indicated by an arrow P9. Subsequently, the second coupling structure 12 can be rotated in the accommodating groove 9 until the holding position is reached, so that the second coupling structure 12 can exert a force on the inner side 10 of the rear wall 3. This rotational movement is visualized by the arrow P10.

FIG. 7B shows the electronic display device 2 with the coupling device 11 coupled thereto. Of course, following successful coupling of the electronic display device 2, the coupling device 11 can also be coupled to the object. As explained, it is advantageous however to couple or to connect the coupling device 11 to the object first, before the coupling device 11 and the electronic display device 2 are coupled or connected. For this, the cords 13d are provided in the exemplary embodiment.

In FIGS. 7C and 7D, these cords 13d are realized as basting threads. Each cord 13d here comprises a lower first crossbrace 13e, which prevents slipping through or slipping out of the cord 13d out of the eyelet 13c, and an upper second crossbrace 13f, which prevents slipping through or slipping out of the cord 13d out of the object. To connect the coupling device 11 to an object and/or the coupling object 11, the cord 13d can be introduced into the object and/or passed through the eyelet 13c by means of a tagging gun.

As illustrated in FIG. 7E, the cord 13d can however also be passed through the eyelet 13c and through the object or around the object (not illustrated in FIG. 7E, but see FIG. 8) and be connected to itself. The connection of the cord 13d to itself can here take place for example by means of a welded connection, an adhesive connection, a plug connection or by means of knots.

In FIG. 8, the electronic display device 2 hangs in a freely dangling manner, by means of coupling device 11, on the pillow 19, which is offered as a product for sale and is presented lying on a bed.

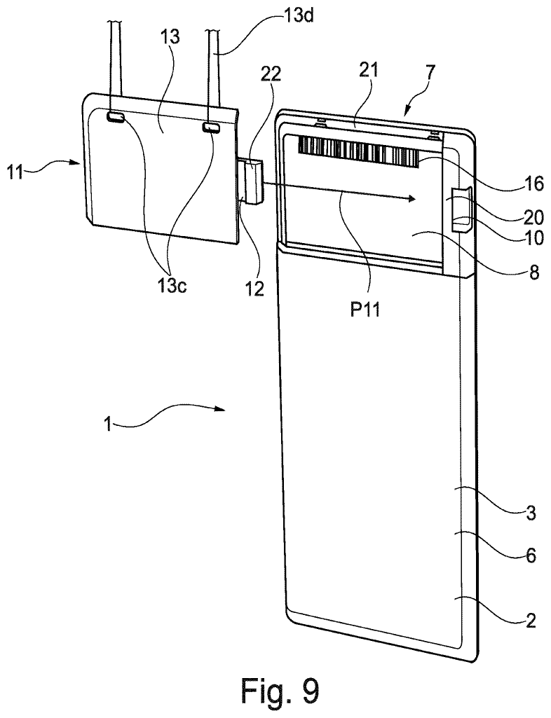

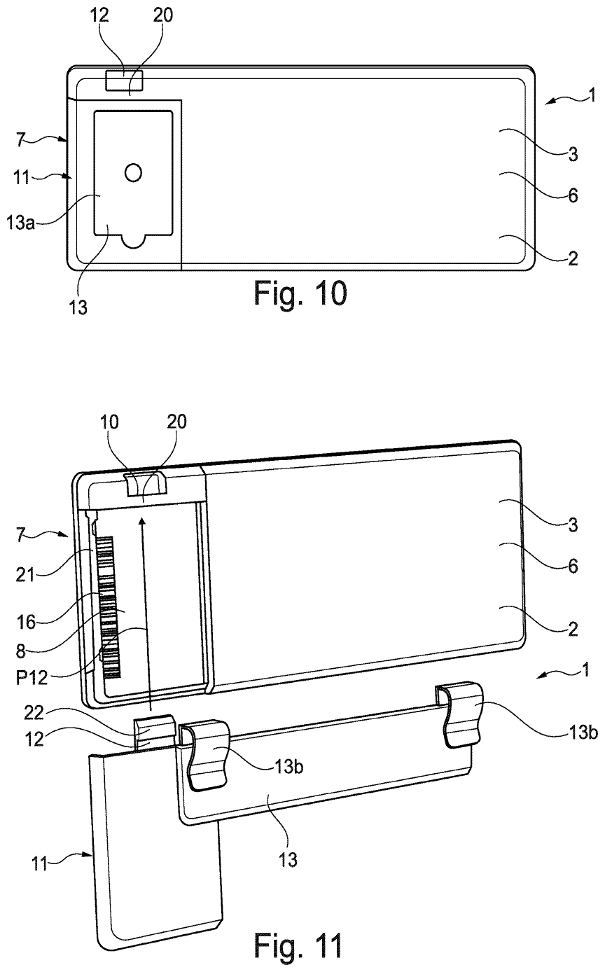

FIGS. 9 to 11 show further embodiments of the electronic display device 2 and the coupling device 11. Here, the first coupling structure 7 and the second coupling structure 12 are designed for coupling by means of a substantially translational movement. For this, the second coupling structure 12 of the coupling device 11 comprises a snap hook 22. The first coupling structure 7 of the electronic display device 2 comprises a bridge-like structure 20, on the inner side of which the inner side 10 of the rear wall 2 extends. The snap hook 22 of the second coupling structure 12 can be passed through the bridge-like structure 20, wherein a deformation of the snap hook 22 occurs during passage through in the introduction direction. The introduction direction here corresponds to the direction that is visualized by an arrow P11 in FIG. 9 and arrow P12 in FIG. 11. The arrow direction of the arrows P11 and P12 runs substantially parallel to the rear wall 2. In the introduced state, the snap hook 22 protrudes out of the bridge-like structure 20, strictly speaking out of the bridge-like structure 20, out of the recess located there, as is illustrated in FIG. 10. Here, the snap hook 22 is no longer deformed and prevents pulling back of the coupling device counter to the introduction direction in that it contacts the bridge-like structure 20 on its surface normal to the introduction direction, that is to say normal to the direction indicated by the arrow P11 or P12. In this introduced state, the second coupling structure 12 engages behind the inner side 10 of the rear wall 2 so that the bridge-like structure 20 prevents a lifting of the coupling device 11 away from the electronic display device 2. The second coupling structure 12 therefore engages behind the bridge-like structure 20, which forms a web, and therefore the inner side 10 of the rear wall 2, which extends there, so that coupling is provided as a consequence of the force transfer by the second coupling structure 12 to the inner side 10 of the rear wall 2.

Furthermore, the electronic display device 2 comprises a guide rail 21 which is designed to guide the coupling device 11 in the introduction direction during coupling. The guide rail 21 comprises a railhead which comprises an overhang which extends along the narrow side of the electronic display device 2 (possibly also along the long side of the electronic display device 2 in the region to be occupied by the coupling device). The guide rail 21 therefore prevents folding out of the coupling device 11 and therefore improves the coupling action. The guide rail 21 is, like the entire electronic display device 2 also, designed to be coupled to different coupling devices 11 which differ due to their third coupling structure 13.

FIG. 9 here shows the coupling device 9 which comprises a third coupling structure 13 which is designed for a freely suspended or for a freely dangling attachment to an object. For this, the coupling device 9 comprises eyelets 13c, through which the cords 13d are guided. In order to achieve optimum coupling of such a coupling device 11 to the electronic display device 2, the guide rail 21 comprises recesses which, depending on the embodiment, permit passage of the cords 13 through the guide rail 21 or passage of the cords 13 past the guide rail 21. The coupling device 11 and the electronic display device 2 can thus be coupled without the cords 13 being crushed. Therefore, a problem-free subsequent adjustment of the cords 13d is enabled.

FIG. 10 shows the coupling device 11 which comprises a third coupling structure 13 for providing an adhesive connection. For this, the third coupling structure 13 is designed as an adhesive film 13a.

FIG. 11 shows the coupling device 11 which is designed to be clamped or suspended onto an object. For this, the coupling device 11 or the third coupling structure 13 thereof comprises two clamps 13b or tabs. This third coupling structure 13 is here designed similarly to that which is visualized in FIGS. 5 or 6A and 6B, but with the difference that it extends for the most part to the side (only to one side) of the second coupling structure 12.

The first coupling structure 7 is here accommodated in FIGS. 9 to 11 on the left side of the rear wall 2. Of course, the first coupling structure 7 can also be attached at different points, for example centrally or on the right. When choosing a different position of the first coupling structure 7, the coupling device 11 is accordingly to be adapted to the chosen position of the first coupling structure 7.

Finally, it is once more noted that the figures previously described in detail are only concerned with exemplary embodiments which can be modified in many different ways by a person skilled in the art without departing from the scope of the invention. For the sake of completeness, it is also noted that the use of the indefinite article “a” or “an” does not mean that the relevant features cannot also be present multiple times.

1. An electronic display device (2) for displaying product and/or price information, which comprises:
a housing (6) which comprises a front wall (4), which comprises a screen (5), and a rear wall (3), which faces away from the front wall (4), wherein the housing (6) is designed for interacting with a dimensionally stable coupling device (11) for the purpose of coupling the electronic display device (2) and an object (17, 18, 19), wherein the housing (6) comprises a first coupling structure (7) which is formed on its rear wall (3),
wherein the first coupling structure (7) is designed for detachably holding or detachably fastening the coupling device (11), and
wherein the first coupling structure (7) is designed in such a manner that the coupling is based on force transfer from the coupling device (11) to the inner side (10) of the rear wall (3).

2. The electronic display device (2) according to claim 1, characterized in that at least one part of the rear wall (3) is designed, as a constituent of the first coupling structure (7), such that it is possible to engage behind it.

3. The electronic display device (2) according to claim 2, characterized in that the first coupling structure (7) comprises a coupling indentation or coupling recess in the region where it is possible to engage behind the rear wall, which coupling indentation or coupling recess is designed for accommodating the coupling device (11).

4. The electronic display device (2) according to claim 1, wherein the first coupling structure (7) is formed by the inner side (10) of the rear wall (2) at least in some regions.

5. The electronic display device (2) according to claim 1, wherein the first coupling structure (7) comprises an accommodating groove (9) or an accommodating slot located inside the electronic display device for accommodating the coupling device (11).

6. The electronic display device (2) according to claim 1, wherein the first coupling structure (7) is designed and adapted to the coupling device (11) in such a manner that the electronic display device (2) and the coupling device (11) can be plugged into one another, wherein the first coupling structure (7) is designed in such a manner that the coupling device (11) in the plugged-in state can be rotated into a holding position.

7. A coupling device (11) for coupling an electronic display device (2) for displaying product and/or price information to an object (17, 18, 19),
wherein the coupling device (11) is designed in a dimensionally stable manner
and wherein the coupling device (11) comprises a second coupling structure (12) which is designed for detachably holding or detachably fastening the electronic display device (2), and wherein the second coupling structure (12) is designed in such a manner that the coupling is based on force transfer from the coupling device (11) to an inner side (10) of a rear wall (3) of the electronic display device (2).

8. The coupling device (11) according to claim 7, wherein the second coupling structure (12) is designed in a substantially extensive or disc-like or plate-like manner.

9. The coupling device (11) according to claim 7, wherein the second coupling structure (12) comprises a prismatic shape or a prismatic shape comprising rounded and/or milled corners and/or edges, preferably comprises a rotationally symmetrical base area, particularly preferably the base area corresponds to a regular polygon, particularly a square.

10. The coupling device (11) according to claim 7, wherein the second coupling structure (12) is designed and adapted to the electronic display device (2) in such a manner that the electronic display device (2) and the coupling device (11) can be plugged into one another and wherein the second coupling structure (12) is designed in such a manner that the coupling device (11) in the plugged-in state can be rotated into a holding position.

11. The coupling device (11) according to claim 7, which comprises a third coupling structure (13) which is designed to couple the coupling device (11) to the object (17, 18, 19) in a manner adapted to the object (17, 18, 19).

12. The coupling device (11) according to claim 11, wherein the third coupling structure (13) is designed to make a force-fitting and/or form-fitting connection to the object (17, 18, 19).

13. The coupling device (11) according to claim 11, wherein the third coupling structure (13) is designed to accommodate cords (13d), cables, threads, wires or similar or that the third coupling structure (13) itself is designed in a cord-like manner at least in some regions.

14. The coupling device (11) according to claim 11, wherein the third coupling structure (13) is designed to grasp the object (17, 18, 19) at least partially, particularly to be clamped or hung on the object (17, 18, 19), or to spread with the object (17, 18, 19).

15. The coupling device (11) according to claim 11, wherein the third coupling structure (13) is designed to undergo an adhesive connection to the object (17, 18, 19), in particular wherein the third coupling structure (13) comprises an adhesive layer (13a) or is designed as an adhesive layer (13a).

16. The coupling device (11) according to claim 7, which comprises a coupling-tool receptacle (14) which is designed to accommodate a coupling tool (15).

17. A coupling tool (15) which is designed to fasten a coupling device (11) according to claim 7 to an object (17, 18, 19) or detach said coupling device from the same or fasten said coupling device to an electronic display device (2) according to claim 1 or detach said coupling device from the same.

18. A fastening system (1), shortened to system (1), which comprises at least one electronic display device (2) according to claim 1 and at least one coupling device (11) according to claim 7.

19. (canceled)
